(19) United States
(12) Patent Application Publication
(10) Pub. No.: US 2011/0125749 A1
(43) Pub. Date: May 26, 2011

(54) Method and Apparatus for Storing and Indexing High-Speed Network Traffic Data

(75) Inventors: Matthew S. Wood, Salt Lake City, UT (US); Joseph H. Levy, Eagle Mountain, UT (US); Paal Tveit, Salt Lake City, UT (US)

(73) Assignee: Solera Networks, Inc., South Jordan, UT (US)

(21) Appl. No.: 12/946,559

(22) Filed: Nov. 15, 2010

Related U.S. Application Data
(60) Provisional application No. 61/261,363, filed on Nov. 15, 2009.

(51) Int. Cl. G06F 17/30

(52) U.S. Cl. 707/737; 707/741; 707/747; 707/E17.002; 707/E17.046

(57) ABSTRACT

Storing and indexing of high-speed network traffic data is disclosed. In one embodiment, a method of network database maintenance includes sequentially recording in real-time packet header and/or packet content attributes derived from network packets captured and stored in one of a packet capture repository and a file system in database units ordered by arrival of the network packet data. In addition, the method includes indexing each database unit to point to a memory location of the network packet data in one of the packet capture repository and the file system. The method also includes computing a hash value on certain input data and creating index bitmaps on each database unit to facilitate grouping of a similar attributes associated with the network packet data recorded in the database units. The resulting data may then be stored in compressed and/or encrypted formats on a file system for efficiency and security.

### RELATED APPLICATIONS

The application claims priority under 35 U.S.C. §119(e) to U.S. Provisional Application Ser. No. 61/261,363, Nov. 15, 2009, which is herein incorporated by reference in its entirety, and in particular to method and apparatus for real time identification and recording of artifacts.

### FIELD OF TECHNOLOGY

This disclosure relates generally to a technical field of computer networking and database management, and in particular, to a method and apparatus for storing and indexing high-speed network traffic data.

### BACKGROUND

Efficient network and cyber security operations may involve a data collection component for the purpose of retrospective forensic analysis of select time periods, events, or agents of interest. As records of transmitted network packet data may be recorded for subsequent analysis, a database of the aforementioned records are frequently maintained to facilitate efficient location and retrieval. Protection from network predators warrants a need not only to read from the database quickly but also to rapidly insert records into the database. The ability to meet such stringent demands may be impaired by the performance limitations of available hardware.

### SUMMARY

Disclosed are methods and apparatus for storing and indexing high-speed network traffic data. In one aspect, a method of network database maintenance includes sequentially recording in real-time packet header and/or packet content attributes derived from network packets captured and stored in one of a packet capture repository and a file system in database units ordered by arrival of the network packet data. In addition, the method includes indexing each database unit of the database units to point to a memory location of the network packet data in one of the packet capture repository and the file system. Further, the method includes creating a plurality of hashes on select database units and index bitmaps on each hash value or database unit of the database units to facilitate grouping of a similar attributes associated with the network packet data recorded in the database units. The method also includes the ability to write the hashes, bitmaps, and database units in compressed and/or encrypted formats, and to decompress and/or decrypt said elements for read processes.

A size of each database unit of the database units may be based on a size of the packet header or content information associated with the network packet data included thereof. The method may include checking for a presence of a network packet data of interest with an aid of the index bitmaps. In addition, the method may include querying the database units to extract a matched packet data in one of the packet capture repository and the file system. The header information associated with the network packet data may include protocol types, encapsulation types, physical identifying information, source identification data, or a destination identification data. The packet content may include protocol or application identification, or an artifact type including any of a word processing document, a spreadsheet document, a database, a multimedia content, a multimedia file, an e-mail, an instant messaging (IM) communication, a compressed file, an executable file, a web page, a presentation document, a program file, and a data package. The protocol type associated with the network packet data may include a hypertext transfer protocol (HTTP), a simple mail transfer protocol (SMTP), a remote procedure call (RPC) protocol, voice over internet protocol (VoIP), a peer to peer protocol, a file transfer protocol (FTP), a streaming media protocol, an IM protocol, etc.

In addition, the method may include reconstructing TCP packet flows or conversations from the packet data stored in the packet capture repository. For example, transmission of a program file over a network may involve numerous packets transporting discrete portions of he program file, but not the entirety of the program file. A receiving computer must receive all of the packets pertaining to the program file. Hence, reconstructing a flow may involve obtaining and ordering the packets for a specific program file. Similarly, a conversation may involve packets transmitted back-and-forth between a computer requesting information, e.g., a client, and a computer delivering information, e.g., a server. The term “conversation,” in this example, refers to the packetized communication occurring between the two computers, and reconstruction may involve delineating the beginning and end of the conversation, and identifying and/or ordering the packets related to the conversation. The method may also include performing a data analytics, data statistics, data forensics, and/or data metrics based on the matched packet data in one of the packet capture repository and the file system. The method may include querying the database to apply a pattern matching scheme to extract the matched packet data in one of the packet capture repository and the file system. The reconstructing the matched packet data may include presenting information associated with the matched packet data in a suitable format to convenience analysis of the presented information.

In another aspect, a method of network database maintenance includes inserting in real-time a header or content information associated with a network packet data to be stored in one of a packet capture repository and a file system in any of a database unit of database units that includes recorded header information associated with packet data stored in one of the packet capture repository and the file system. In addition, the method includes indexing each of the database unit of the database units to point to a memory location of the network packet data in one of the packet capture repository and the file system. The method also includes updating each of index bitmap of index bitmaps on the database unit of the database units to group the header or content information associated with the network packet data with a similar header or content information associated with network packet data recorded in the database unit. “Similar” content here refers to the fact that two or more packets with an identical attribute stored in a single database unit have the same signature as that of a single packet with said attribute. That is, an entry in the bitmap for a particular attribute looks the same regardless of 1, 2, 3, . . . , etc. packets in a database unit share that attribute.

In yet another aspect, a system includes one of a packet capture repository and a file system to store a header or content information associated with a network packet data. In addition, the system includes an index module to index each database unit of database units to point to a memory location of the network packet data in one of the packet capture repository and the file system. On certain database units, a mathematical hash function is performed to convert a variable or relatively large amount of data (e.g. a value such as an IPv6 address which contains 128 bits of information and which cannot be concisely represented with a bitmap) into a smaller value referred to as a “hash.” The index bitmaps are created on each hash and/or each database unit of the database units to facilitate grouping of similar header or content information associated with the network packet data sequentially recorded in real-time in the database units in an order of arrival of the network packet data. The network packet data may be from any of an Asynchronous Transfer Mode (ATM) network, an Ethernet, a 3G network, a 4G network, and a wireless network. The hash values, index bitmaps, and database units may then be compressed to conserve both storage space and data-bus and peripheral input/output (I/O) operations, and they may also be encrypted so as to secure the confidentiality and integrity of the data. The reverse of these compression and encryption functions will be applied as a function of the read-path of the data.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of accompanying drawings, in which like references indicate similar elements and in which:

FIG. 1 is a process flow detailing operations involved in generation of bitmaps on each database unit, in accordance with one or more embodiments.

FIG. 2 illustrates a network packet header structure 200, according to an example embodiment.

FIG. 3 illustrates a process of recording network packet header information or network flow information in real time and storing the information in a packet capture repository, according to one or more embodiments.

FIG. 4 illustrates a “wedding cake” analogy for maintenance of a network database, according to one embodiment.

FIG. 5 is a process flow illustrating insertion of header information in a database unit, the header information associated with a network packet or network flow and updating the index bitmap, according to one or more embodiments.

FIG. 6 is a process of inserting network packet header information or network flow information in database units in real time and storing the information in the packet capture repository, according to one or more embodiments.

FIG. 7 is a system view illustrating a communication network that includes devices to capture and record header information of the packets, according to one or more embodiments.

FIG. 8 is a diagram illustrating a relationship between a packet capture repository including slots, an indexed database including database units, and index hashes and bitmaps for the database units.

FIG. 9 is a diagram illustrating an index bitmap for a protocol database unit.

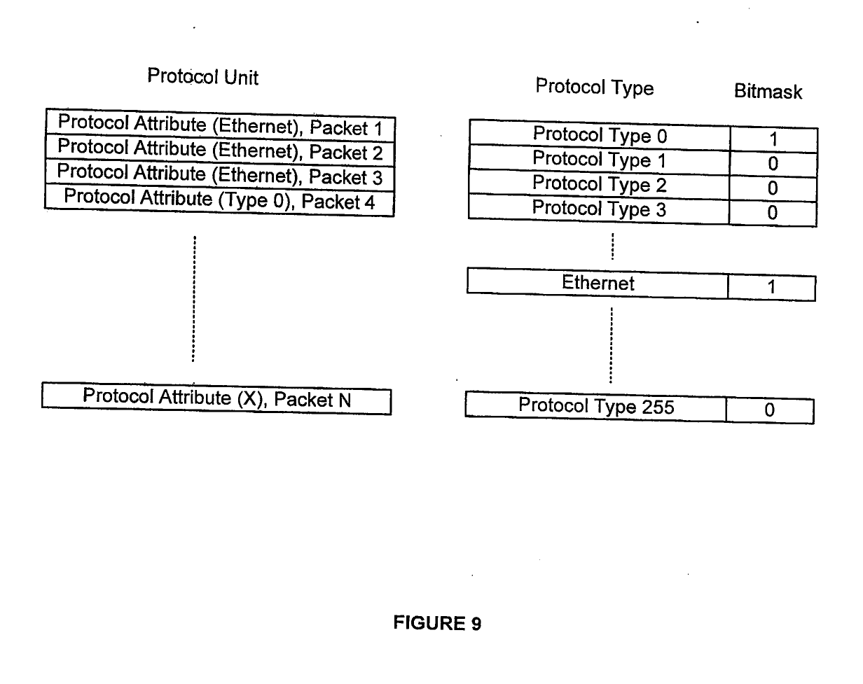

Other features of the present embodiments will be apparent from accompanying Drawings and from the Detailed Description that follows.

### DETAILED DESCRIPTION

Aspects of the present invention involve a storage, indexing, and processing hierarchy that facilitates efficient searching of large amounts of data, and particularly searching network data packets. Aspects of the invention further involve a low overhead method and apparatus of searching the data packets for packets of interest by using a combination of compression, encryption, hashes, and bitmaps with bits that are set based on various network packet or network flow attributes, or their respective content.

Example embodiments, as described below, may be used to provide method and apparatus for storing and indexing high-speed network traffic data. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

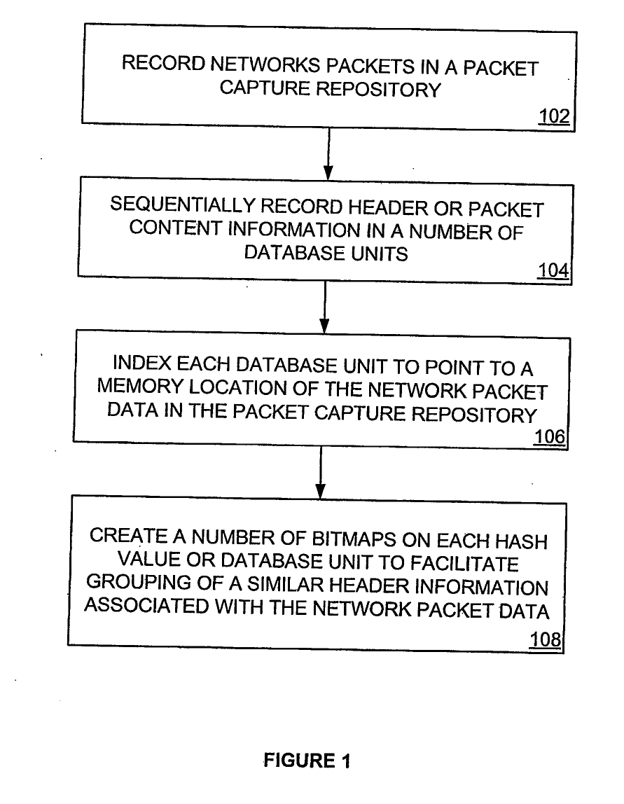

FIG. 1 is a process flow detailing the operations involved in generation of bitmaps on each database unit, in accordance with one or more embodiments. To begin, network packets flowing over a network are recorded in a network packet capture repository (operation 102). In one particular example, a network tap provides a replicate flow of packets without interrupting the flow of packets on the network. For example, a network tap is placed in a network line, e.g., Ethernet cable, fiber optic cable, etc., and the packets flowing through the network line continue normally through the tap, while a replicate flow of packets is also provided on the network tap. The replicate flow of packets is stored in database slots, which may be 64 MB memory allocations or other size. One method and system of storing packets in network slot or otherwise storing packets is described in published PCT application PCT/US2005/045566 titled “Method and Apparatus for Network Packet Capture Distributed Storage System,” (WO 2006/071560), which is hereby incorporated by reference herein. The flow of packets is stored in the order of receipt and may or may not have inclusive or exclusive filtering applied as a criterion for storage. Like network packet flow generally, the packets stored in the database slots are not necessarily contiguous and complete information. Possible terms for a contiguous and complete collection of packets is a “conversation” or a “flow.” Examples of flows would be all packets of an email communication or all packets of a website request or delivery. In one particular example, the network slots are fixed size memory allocations capable of accepting packets of variable size and without filling the entire slot memory allocation. Depending on the location in a network of any given tap, a tremendous number of packets may be flowing over the network and stored in the network packet capture repository.

In conjunction with storing the network packets in the packet capture repository, header or content information associated with the network packet data or network flow is sequentially recorded in a number of database units in an order of arrival of the network packet data (operation 104). Recordation of the header or content information may be performed following or contemporaneously with the recordation of the network packet in the network packet capture repository. Additionally, the state of the network flow corresponding to the recorded network packet is updated in memory. Upon scanning the contents and state of the network flow, additional attributes specific to the conversation may be recorded.

In one or more embodiments, the size of each database unit is based on a size of the header or content information associated with the network packet data. For example, the record size of a database unit for storing TCP ports is two (2) bytes. In one specific implementation, the upper limit on the total size of a database unit corresponds to the number of packets that may be stored in a slot.

Further, in a specific implementation, database units are dedicated to particular header types or contention information, i.e. packet attributes. For example, a database unit may be allocated to source IP addresses for packets on a single slot and another database unit may be allocated to destination IP addresses for packets on the same slot. Hence, one database unit would accumulate source IP addresses in the same order as packets are received in the network packet capture repository and another database unit would accumulate destination IP addresses in the same order as packets are received in the network packet capture repository. Further, in this example, the first memory location in each database unit would correspond to source and destination addresses of the first packet received in the network packet repository (or slot), the second memory locations in each unit would correspond to the source and destination addresses of the second packets received in a slot, and so on.

Stated differently, in one specific implementation, the database units are all stored within a traditional computer file system (e.g. ext3, NTFS, etc.) and there is a mapping between the database units and the slots in the packet capture repository. To with, the packet capture repository has a collection of slots which store the entirety of captured packet, and the containers those packets are stored in have a direct relationship with the database units existing on a standard file system that contain the index for the packets in the containers. Hence, the units are indexed to the slots both due to the matching sequence between each unit and a respective slot and/or the database unit file system indexing of the packets in the slots. Additional information concerning an indexed database, including database units, as well as other information may be found in provisional application No. 61/261,365 titled “Method and Apparatus for Real Time Identification and Storage of Artifacts.” File Nov. 15, 2009 (attorney docket no. P2007008.US.01), which is hereby incorporated by reference herein.

To facilitate efficient searching of the network packet capture repository, each database unit is indexed to point to a memory location of the network packet data in the packet capture repository. Hence, each unit indexes the location of the complete captured packet in a slot inclusive of the location on a capture disk providing the physical storage of the data. In one specific implementation, database units may include a hash value derived from a mathematical hash function. In another implementation, database units may include a bitmap, also referred to as a bitmask herein. One or more bitmaps may be created on each has value and/or database unit to facilitate grouping of similar header or content information associated with the network packet data and/or to facilitate quick lookup of a specific header attribute associated with the network packet data. In one or more embodiments, the bitmaps provide information about presence of network packet data of interest in the packet capture repository. In one or more embodiments, the computed has, index, and database unit information may be further processed according to some compression and/or encryption function. The network packet header or network flow may include several fields that serve as parameters for grouping in a database unit as well as the definition of some or all of the database units.

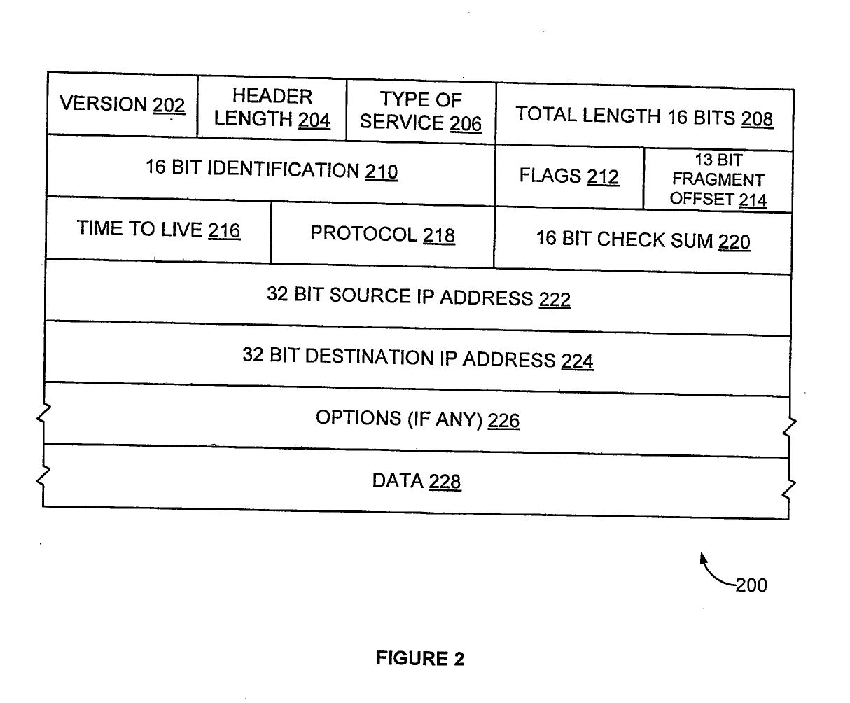

For purposes of discussion, FIG. 2 illustrates one example of a network packet header structure 200 for an IPv4 packet. Other network packet types, such as IPv6, etc., may have different fields than those shown in FIG. 2. Any given network packet header may include several fields that provide useful information. For example, the network packet header may provide information about the protocol under which the packet was transmitted and the session in which the network packet was communicated. The packet header shown in FIG. 2 includes version field 202, a header length field 204, a type of service field 206, a total length field 208, a 16 bit identification field 210, flags field 212, a 13 bit fragment offset field 214, a time to live 216, a protocol field 218, a 16 bit checksum field 220, a 32 bit source IP address field 222, a 32 bit destination IP address field 224, an options field 226 and a data field 228.

Data is communicated over a network in the form of packets. Data packets may be used to transmit useful information between computing devices. Generally speaking, useful information, such as a webpage or a word processing document, is divided into discrete portions and a plurality of data packets, often including a variety of encoding transformations, are used to convey the information between computers. In aggregate, the plurality of data packets in proper sequential order represents a network flow. The data packets are routed, often out of order and by way of different paths, to a receiving computer over a network. The receiving computer, then reassembles the useful information from the data packets.

The data packets being communicated in the network may be associated with any form of useful or interesting information, also referred to herein as an “artifact.” For example, packets may convey artifacts such as a word processing document, a spread sheet document, a database, multimedia content, a multimedia file, an e-mail, an instant messaging (IM) communication, a compressed file, an executable file, a web page, a presentation document, a program file, a data package, a protocol identification, etc. Furthermore, the network packet data may be from any of, but not limited to an Asynchronous Transfer Mode (ATM) network, an Ethernet, a 3G network, a 4G network, and/or a wireless network. To reassemble the artifacts conveyed by data packets, network packets typically include packet header or content information about the session or conversation associated with the network packets.

The network packet headers or content having similar information may be processed by a hash function and grouped in a database unit under an index bitmap that identifies the presence of packets with a particular packet header attribute or content. There may be a variety of network packet header or content categories, such as IP address, flow statistics, protocol classification, number of artifacts transmitted, etc. The network packet headers or contents may be grouped based on some common attribute of the packets or network flows. In one or more embodiments, the network packet headers may be grouped based on the session, based on the source, destination, etc. For example, the network packet data may be transmitted from a source computing device to a destination computing device. The network packet data being transmitted may include a source IP address and a destination IP address programmed into their network packet headers. The incoming network packets from a particular source to a particular destination may each have identical source IP addresses and identical destination IP addresses; (i.e. the parameters, 32 bit source IP addresses of the network packets may have identical values indicating a source IP address and 32 bit destination IP addresses of the network packets may also have identical values indicating a destination IP address). As the headers of the network packets have same information in particular parameters (i.e., the 32 bit source IP address fields identical and the 32 bit destination IP address fields identical), the network headers' information with the identical parameters (e.g., the 32 bit source IP address and the 32 bit destination IP address) may be processed by a hash function and grouped under a particular index bitmap. In one or more embodiments, the network packet headers may also be grouped based on particular type of header information. In one example, grouping is achieved by storing the same type of packet attribute, e.g., source or destination address, in distinct units and including a distinct bit map for each unit. In one or more embodiments, the network packet content may also be grouped based on an application or protocol type identified through content inspection or pattern matching, or by network flow.

In the example embodiment, the network packet header includes multiple fields and each of the fields can be used as parameters for grouping. Further, the network flow includes multiple attributes which may also be used as parameters for grouping. Each of the fields in the network packet header or attributes in a network flow has a unique value that distinguishes each of the network packets or network flows from another. The version field 202 may specify a format of IP packet header. The header length field 204 may specify a length of the IP packet header in 32 bit words. The type of service field 206 may specify the variables for the type of service requested to manage a datagram during transport. The total length field 208 may specify the length of the datagram. The 16 bit identification field 210 may be used to identify the fragments of one datagram from those of another. The flags field 212 may control the fragmentation and indicates presence of additional fragments. Any of these fields may be processed through a hash function to produce a more efficient representation of the input data.

The 13-bit fragment offset field 214 may be used to direct the reassembly of a fragmented datagram. The time to live field 216 may specify the lifetime of the datagram. The protocol field 218 may specify the encapsulated protocol. The 16 bit checksum field 220 may specify the checksum of the header. The 32 bit source IP address field 222 may specify the source IP address and the 32 bit destination IP address field 224 may specify the destination IP address. The options field 226 may specify various options based on associated references and the data field 228 may carry data. Any of the aforementioned fields may be processed through a hash function. The aforementioned fields, processed or unprocessed, may also be chosen to be used as parameters for grouping under various index bitmaps based on certain criteria.

The aforementioned fields may be associated to particular network packet header structure 200 illustrated in the FIG. 2. It will be appreciated that while one type of network packet header is illustrated, the embodiments disclosed herein can also be applied to other kinds of network packets, including, but not limited to IPv6 packets.

Furthermore, the protocol types associated with the network packet data may include any of, but not limited to a hypertext transfer protocol (HTTP), a simple mail transfer protocol (SMTP), a remote procedure call (RPC) protocol, voice over internet protocol (VoIP), a peer-to-peer protocol, a file transfer protocol (FTP), a streaming media protocol, and an instant messaging protocol.

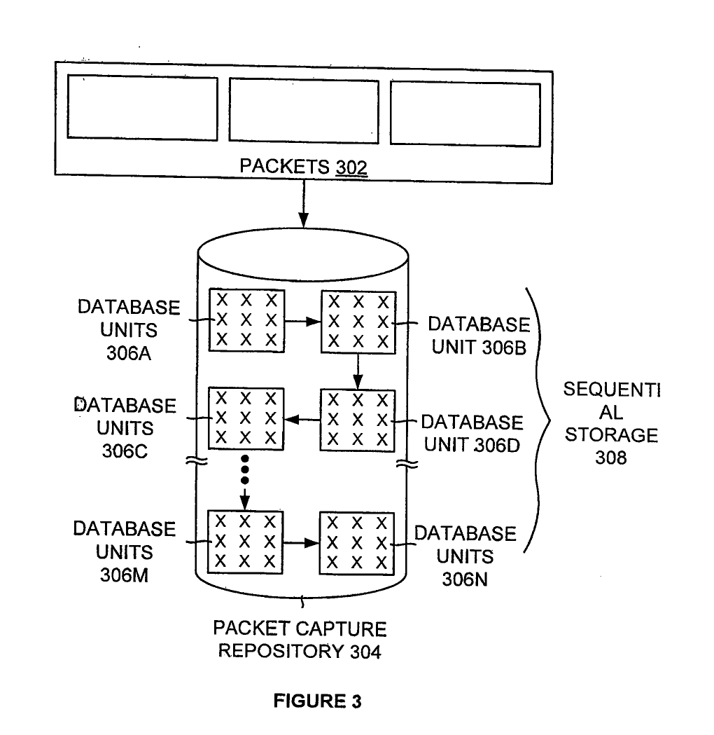

FIG. 3 illustrates a process of recording network packet header information, network flow information, or content information in real time and storing them in a database unit, file system, and/or packet capture repository, according to one or more embodiments. In particular, FIG. 3 illustrates packets 302, a packet capture repository 304, database units 306A-N, and a sequential storage 308, according to one embodiment.

Flow, header or content information of the arriving packets 302 (e.g., the network packets) may be recorded in a real time. In one embodiment, the incoming network packets may be captured using a capture appliance 714 (e.g., Solera Networks™ DS Series™ appliances, etc.) and the header information of the packets or the attribute information of the flows may be recorded. It should be noted that Solera Networks™, DS Series™ are pending U.S. federal trademarks of Solera networks, Inc. Furthermore, it should be noted that recording of header and content information of the network packets may be achieved even without capturing the network packets.

The recorded network packet header and content information may be stored in a file system (e.g., a database file system) in a database unit 306A-N. The packet capture repository may be a part of storage in a storage device 712 that is designed to store the captured network packet header in the database units 306A-N. The size of the each database unit may be based on a size of the header, flow attribute, or content information associated with the network packet. For example, an IPv4 network address attribute requires a minimum of four bytes per database unit record, while a TCP port attribute only requires two bytes per database unit record. In addition, a new database unit is created when the data in the database reaches a threshold limit of storage. For example, if a slot size is 64 MB, then a new slot is created or otherwise allocated for packets after the first slot fills. Similarly, the packet capture repository 304 may create multiple database units, one after the other to store the required amount of information in each of the database units 306A-N. Furthermore, the packet capture repository 304 may be a sequential storage 308 that enables storing of information sequentially in the order of arrival. For example, packets may be stored as a linked list in a slot. As a result, the recorded network packet header information or network flow information may be stored sequentially, or in a sequence that matches that of the packet capture repository, in the database units 306A-N. Hence, each unit allocated to a particular slot, provides an index into the contents of the slot in addition to the attribute of the network packet or network flow stored at a given location. Because of the matching sequences, by identifying a header attribute, flow attribute, or content attribute of interest in a database unit, a searching sequence will immediately know the location of the header attribute or content attribute, will thus be able to determine the location of the entire packet in the slot corresponding the database unit.

Each of the network packets or network flows may differ from the every other network packet or flow in content, size, type, etc. The information associated with the network packet or flow may be identified in the network packet header, content or other attribute. There may be network packets or flows that may be similar to other network packet or flows in one or more attributes of the packet headers, attributes and contents. The network packet headers, flow attributes, and contents having like or similar attributes may be grouped within a database unit, optionally hashed, and represented by an index map. In one or more embodiments, various index bitmaps may be generated on each database unit. The index bitmaps may group the similar header or content information stored in database units. There may be several index bitmaps, each of the index bitmap groups the header or content information associated to the network packets that have like or similar attributes.

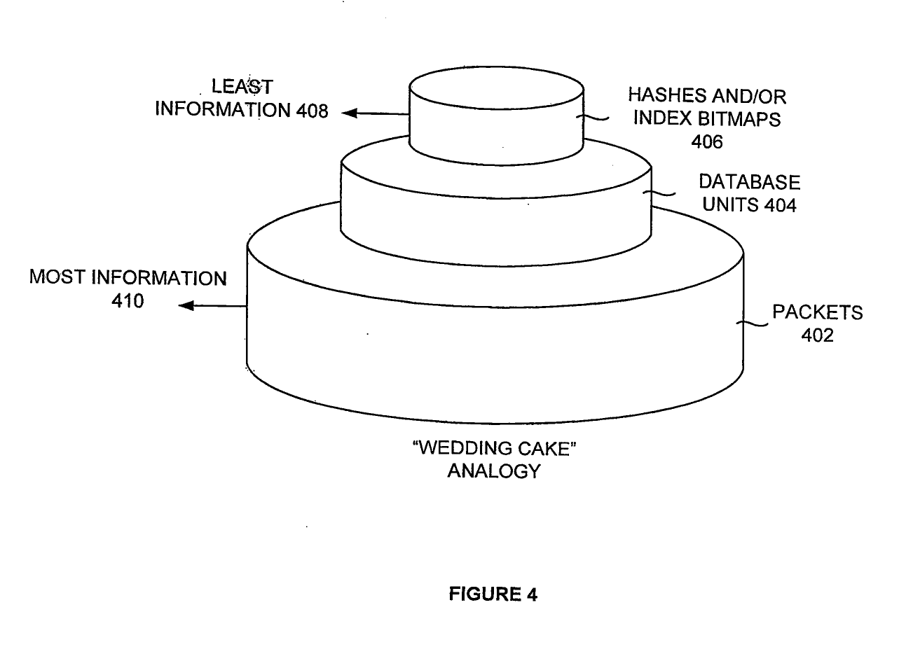

FIG. 4 illustrates a “wedding cake” analogy useful in understanding the relationship between slots, which store packets, database units, which only store particular header attributes, flow information, or content information associated with packets stored in a given slot, and hashes and/or bit maps which provide visibility into the contents of a given unit as well as a given slot. Any of these elements may be further transformed by compression and/or encryption schemes prior to recording. Stated differently, “the wedding cake” analogy illustrates an amount of information provided at different levels and a relationship between the levels of storage. Furthermore, in one or more embodiments, the network database described herein may be packet centric. A packet capture repository may be used to store packets 402, while a file system may be used to store packet header information associated to packets 404, and provide index information associated to presence of packets 406. The file system and database units may also be considered an indexing database, or the functionality provided by the database units may be achieved by an indexing database.

Referring to FIG. 4. a base level of storage provides for storage of packets 402. The packets 402 may be stored in a packet capture repository which may involve a storage device (e.g., the storage device 712). The memory requirement of the packet capture repository may be large, e.g., 10s of Terabytes, as the base level stores the content of the packets 402. Although not shown, it also possible to connect a storage area network (SAN) or other large storage infrastructure, e.g., 100s of Terabytes, to the packet capture repository for additional storage. The database units 404 may have the recorded header, flow, and/or content information associated to the network packets as described in the aforementioned figures. Each of the database units 306A-N may be indexed to point to a memory location of the network packet data in the packet capture repository 304.

As the database units 404 store the recorded header, flow or content information associated to the network packets, the network packet data or flow of interest may be extracted by querying the database units 404 in the storage device 712. The network packet data or flow of interest may be obtained in short time from the database units 404 as the header or content information associated to the network packets may be indexed to point a memory location in the packet capture repository, e.g., a slot. Therefore, the network packet data of interest may be easily located in the storage device 712. The database units 404 may form a middle level in the “wedding cake” analogy as illustrated in FIG. 4.

The top most layer of the “wedding cake” is a layer of the hashes and/or index bitmaps 406. Each of the hashes and/or index bitmaps 406 are provided for a group of similar header or content information associated to the packets 402. In one or more embodiments, the similar header information may be grouped based on matching attributes of the header or content information associated to the packets 402. The information obtained from the hashes and/or index bit masks 406 layer may only provide information about the presence of the packet types in the database units and storage device 712. Therefore, this top layer provides the least information 408 relative to the units and slots, but are also commensurately smaller in size and more quickly searched.

The storage architecture illustrated by FIG. 4 enables better management of records of the communicated network packets and network flows. A presence of a network packet data or flow of interest may be determined with an aid of the hashes and/or index bitmaps 406. If the presence of the network packet data is confirmed through the hashes and/or index bitmaps 406, then the matching network packet data of interest may be extracted querying the database units 404. In one or more embodiments, a pattern matching scheme may be used to extract the matched packet data in the packet capture repository 304/file system of the storage device 712. The network packet data may be reconstructed as a phase of the extraction. The network packet data may be reconstructed in such a way as to present an artifact in its native format, or to present information in a format that enables analysis of the presented information. The analysis may include data analytics, data statistics, data forensics, and/or data metrics based on the matched packet data in one of the packet capture repository and the file system.

The storage architecture also enables better management of records of the communicated network packets and network flows. In addition, the storage architecture speeds up a search process for a particular information associated to the packets 402 without actually going through the process of searching the entire database to find out specific packet information as in traditional approach.

In one example embodiment, a network forensics analyst may want to search for some information associated to particular type of network packets. The network forensics analyst may query the hash and/or index bitmaps 406 layer to find out the presence of the particular type of network packets. The response or the information obtained from the query may be instantaneous as this layer 406 has all the types of header or content information associated to the packets 402 stored in the storage device 712.

Furthermore, the network forensics analyst may retrieve the information associated to the particular packet from the storage device 712 through the database units 404 layer as the database units 404 layer has all the recorded header information indexed logically to point particular memory locations associated to the packets 402 in the storage device 712. Hence, a search of each bit mask (hashed or otherwise) associated with a particular unit is able to identify whether one or more packets having a header attribute, flow attribute, content information, or other attribute, is present in a particular slot. Then by searching the database unit, each memory location of header attributes, flow attributes, content information or otherwise may be identified, which provides visibility into the location of actual packets within the slot having the search criteria. It is also possible to not search the unit, but rather move right to the step of searching the slot or packet capture repository. Hence, time may be saved for the network analyst to obtain the information associated to the particular packet or flow as the presence of the network packet may be instantly found and information associated to the particular packet or flow would be found quickly due to the logical relation between the packets 402 and the database units 404 and the index bit masks, relative to searching every unit or slot without the benefit of first identifying whether the unit or slot has a packet of interest.

In addition, the storage architecture makes it relatively more difficult for network predators to extract information from the storage device 712 as only abstract information would be available from the top level without providing the access or providing proper information about the packets 402 in the storage device 712. The information may be further protected through the use of compression and/or encryption of the data.

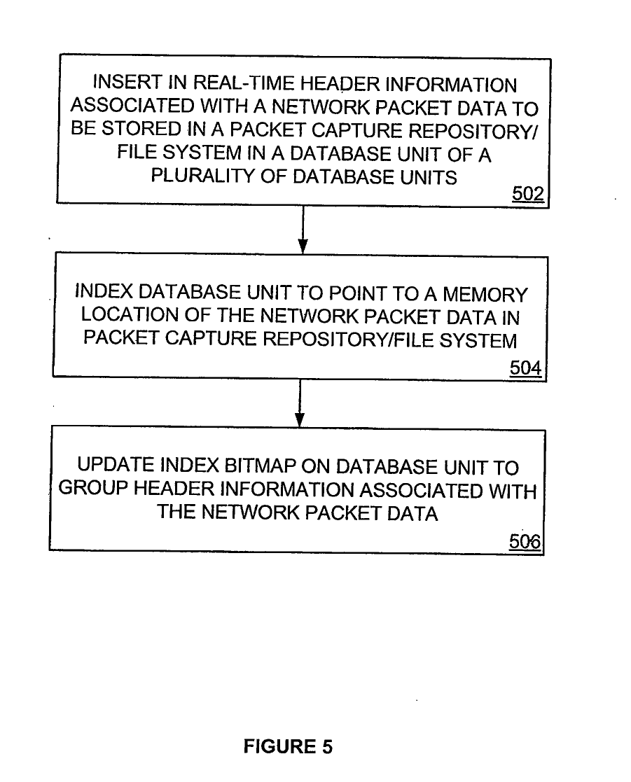

FIG. 5 is a process flow illustrating insertion of header information associated with a network packet in a real time, computing a hash (not illustrated), and updating the index bitmap, according to one or more embodiments. To begin, header or content information associated with a network packet data to be stored in a packet capture repository 304/file system may be inserted in a database unit of the database units 306A-N (operation 502). The database units 306A-N are indexed to point to a memory location of the network packet data in the packet capture repository 304/file system (operation 504). In operation 506, the index bitmap on the database unit may be updated to group header, flow, or content information (hashed or otherwise) associated with the network packet data.

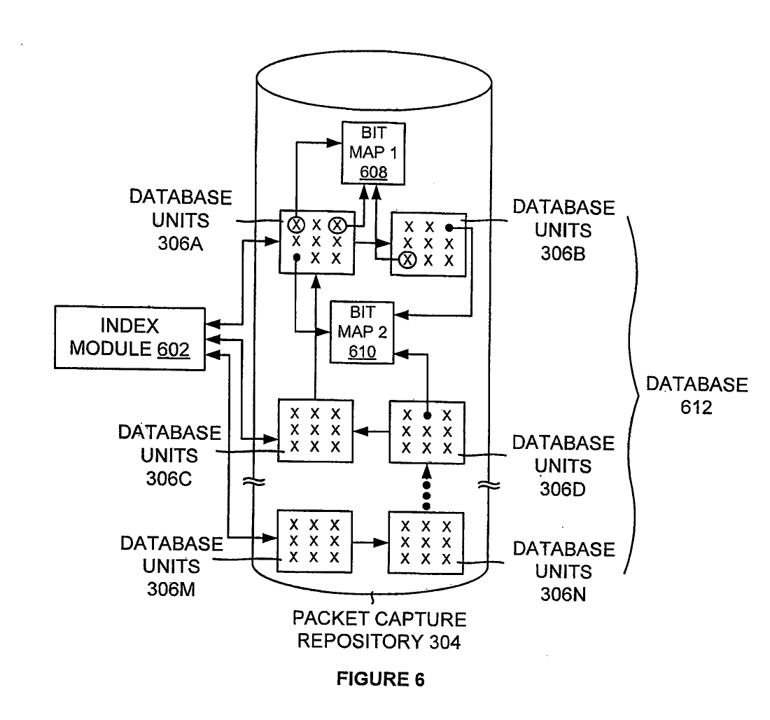

FIG. 6 is a process of inserting network packet header, flow or content information in database units 306A-N in real time and storing them in the packet capture repository, according to one or more embodiments. In particular, FIG. 6 illustrates an index module 602, the packet capture repository 304, the database units 306A-N, a hashing function (not illustrated), a bitmap 1 608, a bitmap 2 610, and database 612, according to one embodiment.

A typical network has a relatively continuous flow of network packets, which may be effected by use. In the examples discussed herein, network packet header or content information is inserted into the database units 306A-N. In one embodiment, header or content information of the incoming network packet data may be recorded and stored in the database units 306A-N in a sequence matching that of the order of packet storage within a packet capture repository. In one or more embodiments, the header or content information may be inserted in any of the already existing database units 306A-N, where the selection of the database unit for insertion is based on alignment to the logical unit of storage within the packet capture repository. In one or more embodiments, the header or content information may be recorded and stored in the database units 306A-N in a sequence determined by manual or heuristic configuration, either related or unrelated to a packet capture repository.

The database units 306A-N may include stored recorded header or flow information associated with the previous packet data. Each of the database unit of the database units 306A-N may be indexed to point a memory location of the network packet data in the packet capture repository using the index module 602. In one or more embodiments, the inserted header, flow, or content information associated to the network packet may be similar to some of the header, flow or content information of the other network packets in the database units 306A-N. In addition, each of the index bitmap has to be updated to provide updated information. Therefore, the inserted header or content information may be added into a group associated to particular index bitmap (hashed or otherwise) that includes the other header, flow or content information having one or more similar attributes which are like or similar to the attributes of the inserted header, flow or content information. Each of the inserted header or content information may be similarly added into the associated groups associated to the respective index bitmaps.

Consider that all bitmaps may be derived from either a hashed or an unhashed data value. In an example embodiment, the bitmap 1 608 may add an inserted header, flow, or content information (e.g., illustrated by cross inside a circle) into a group associated to the bitmap 1 608. Similarly, the bitmap 2 610 may add an inserted header, flow, or content information (e.g., illustrated by filled circle) into a group associated to the bitmap 2 610. The database units 306A-N may constitute the database 612. The database 612 as described herein may be based on the storage architecture discussed herein and in some instances with referenced to the “wedding cake” configuration shown in FIG. 4.

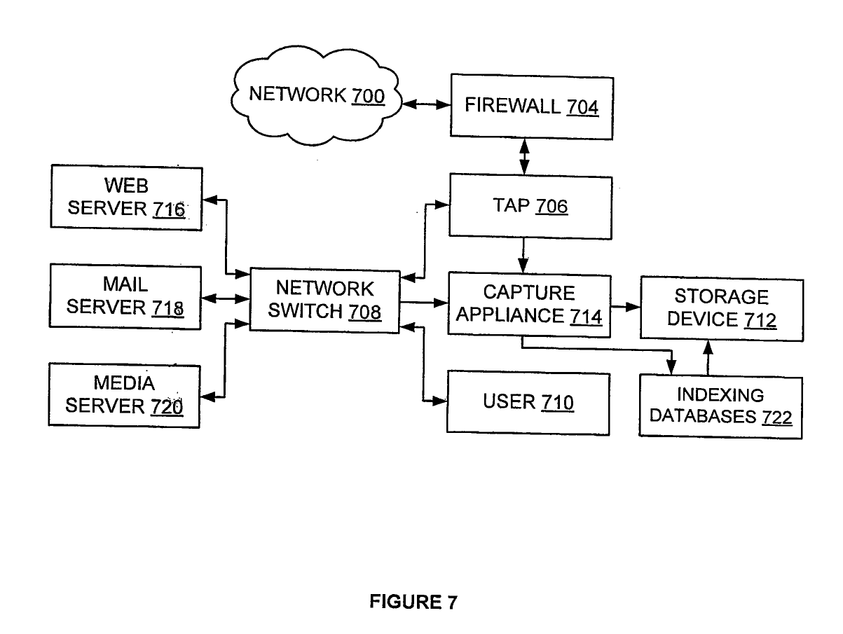

FIG. 7 is a system view illustrating a communication network that includes devices to capture and record header, flow, and content information of the packets, according to one or more embodiments. In particular, FIG. 7 illustrates a network 702, a firewall 704, a tap 706, a network switch 708, a user 710, a storage device 712, a capture appliance 714, a web server 716, a mail server 718, and a media server 720, according to one embodiment.

In an example embodiment, network packets arriving from the network 702 (e.g., WAN, internet, etc.) may be filtered using the firewall 704. The firewall 704 may be a hardware device or a software implementation that is designed to block unauthorized access while permitting authorized communications. The incoming filtered network packets may be tapped by the tap 706. The tap 706 may be a hardware device that provides access to the network packets communicated across a communication line. The network packet flow may be inward or outward to the network 702. The network packet data may be from any of an Asynchronous Transfer Mode (ATM) network, an Ethernet, a 3G network, a 4G network and a wireless network. The network packets transmitted outward may be generated from the web server 716, the mail server 718, the media server 720, etc.

The web server 716, the mail server 718 and the media server 720 may provide services to client devices within an organization or outside the organization through the network 702. The user 710 may be an employee of the organization accessing the network resources. The network switch 708 may be a networking device that connects network segments. The capture appliance 714 (e.g., Solera Networks™ DS Series network forensics Appliance™, etc.) may capture all the network packets (e.g., inward and outward) through the tap. The header information associated to the network packets may be recorded and stored in the storage device 712.

The packet capture repository 304, the file systems, the index module 602, the data base units, the hashing function, and the index bitmaps, may be implemented in the storage device 712. The network packets being stored in the storage device 712 may be maintained using a database management system analogous to the “wedding cake” analogy. The embodiments described in the aforesaid figures may be used to manage the system discussed in the example embodiment. The design as per the analogy may enable insertion of records at a rate of millions of records per second.

The various embodiments described herein may provide a packet centric database that enables insertion of the packets 402 rapidly. In addition, the various embodiments described herein provides the information associated to presence of a particular type of network packet rapidly at the highest level, provides information and locations of the packet at the second level, and enables reconstruction of the packets for analysis at high speeds.

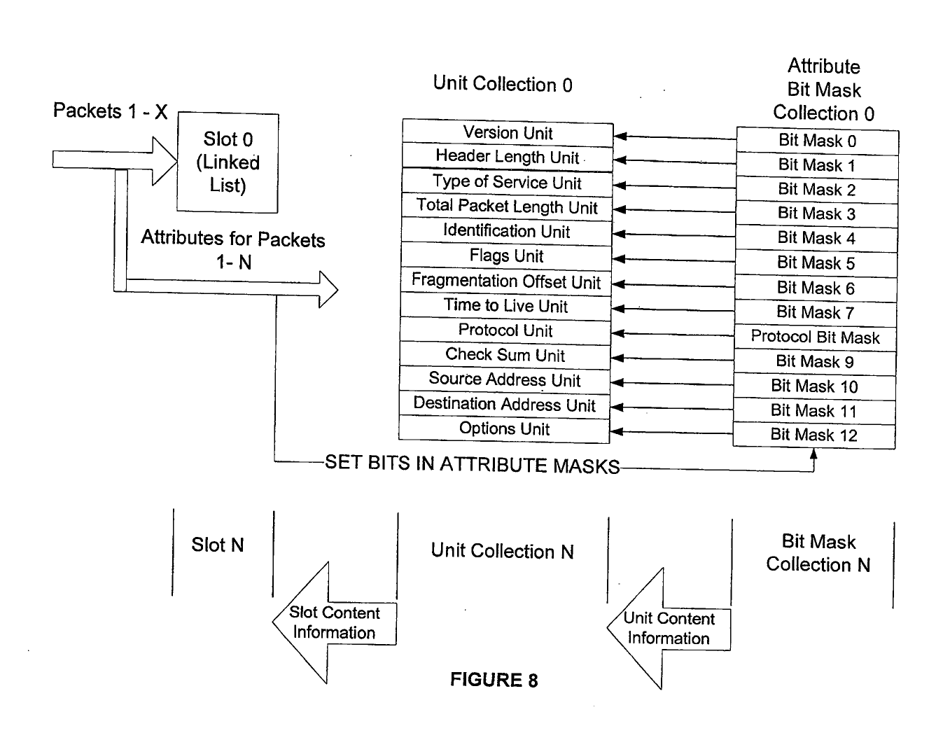

FIG. 8 illustrates one particular example conforming to aspects of the present disclosure. In this example, a single slot 0 is shown. The various parameters discussed relative to FIG. 7 such as slot size, number of slots, number of database units, attribute grouping by units, etc., are subject to change in any particular embodiment. Hence, for example, any given implementation may include any number of slots. For example, approximately 16 Terabytes of linked list slot storage may be allocated across 250 million slots. For each slot, there is a unit collection, including thirteen units 0-12, with one unit for each header attribute, in this specific implementation example. If an implementation is configured to also provides slots for content information, e.g., VoIP data, document data, etc., then additional units may be allocated per slot to additionally store references to such packet content information. Any given implementation may include different numbers of slots depending on the size of the underlying storage and may also include a different number of discrete attributes that the implementation records for visibility and searching granularity into the packet content slot.

For ease of example, FIG. 8 only specifically shows a protocol unit for the protocol attribute 218. Thus, for each packet stored in the slot, the protocol attribute for each packet is stored in the protocol unit. The other twelve units correspond to each of the IPv4 header attributes shown in FIG. 2. For each packet received in the slot, each corresponding unit receives some form of attribute information relevant to the specific header attribute for a given unit. In the FIG. 8/9 example, for each packet linked listed into the slot, there are thirteen discrete packet attributes parsed from the packet and written to the units. In one specific implementation, each unit location is populated based on a given packet is consistent between the units maintaining sequence matching between the slot and each unit allocated to a slot.

Each unit includes a bit mask providing information about the contents of given unit. The bit mask computation may be based on either the original input value (i.e., a bit mask notation of the 16 bit TCP port), or a bitmask notation of a hash value computed given a certain input value. The size and configuration of the bit mask is a function of number of different possible attribute types. In the FIG. 8/9 example, less than 256 different protocol types are recognized. Hence, it is sufficient to provide a 256 bit (32 byte) bit mask, where a discrete bit in the mask corresponds to a discrete protocol type. For example, bit 6 may correspond to IPv4 protocol. Hence, if an IPv4 protocol packet is stored in the slot, bit 6 of the protocol mask is set indicating that the unit contains a reference to at least one IPv4 protocol package, and accordingly the slot contains at least one IPv4 protocol packet. Additional IPv4 packets will not alter the set bit, hence the bit is set for one or more IPv4 packets. Thus, the bit mask indicates the presence of an IPv4 packet attribute in the protocol unit.

In one particular implementation, if four bytes or more of bitmap information is required to provide precise visibility into a database unit, then the bit map may be split or otherwise divided. For example, IPv4 addresses may be numerous. One example of an IPv4 address is 10.1.1.1. A bit map for the IPv4 addresses may be divided into a bitmap for the first two octets of the address, e.g., 10.1, and a second bitmap for the second two octets of the address, e.g., 1.1. In another implementation, the entire IPv4 address 10.1.1.1 may be processed by a hash function designed to transform the 32 bits of the IPv4 address into, for example, a 16 bit hash value. That hash value may then be represented within 16 bits of a single bitmap.

As discussed herein, the slot, the units, and the bit mask have different amounts of data, with the bit mask being the least, each unit being less than the slot, and the slot having the largest amount of data. Simply searching all of the slots for IPv4 protocol packets, some 16 Terabytes, would clearly be more time consuming and more processor and I/O intensive than merely searching the protocol units (not the other units), which is less than simply searching for a set bit in the mask.

For example, using the architecture set forth herein, to find IPv4 protocol packets in the packet capture repository, a search first checks the bit mask for each unit/slot to determine if the IPv4 protocol mask bit is set. The process of checking the bit mask may include determining whether encryption, indexing, and/or hashing was used in the recording of said data, and applying the appropriate transformations to evaluate the required bit mask values. By checking for an appropriate combination of bits, the search can efficiently determine whether there is an instance of an IPv4 protocol packet present in a given slot. Rather, however, than searching the entire contents of the slot to determine whether a given packet has a protocol header value corresponding to an IPv4 packet, it is possible for the search to identify the memory location of each IPv4 protocol attribute in the protocol unit for the slot. The memory location of the unit corresponds to a memory location in the slot for the packet with the IPv4 attribute. Hence, for example, if unit location 0 has an IPv4 protocol attribute, then slot location 0 has an IPv4 packet. Thus, the search is able to determine the slot memory location by first searching the unit. If the IPv4 mask bit was not set, then the search would be able to avoid searching the unit and the slot completely, as the search would recognize that no IPv4 packets are present in the slot and no IPv4 attributes are present in the unit. Hence, the slot, unit, bit mask architecture set forth herein provides an efficient way to provide visibility into the slot contents.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed:

1. A method of network database maintenance comprising:
sequentially recording in real-time packetheader, packet flow and/or packet content attributes in a plurality of database units in an order of arrival of the network packet data, the packet header, packet flow and/or packet content attributes derived from network packets captured and stored in one of a packet capture repository and a file system;
indexing each database unit of the plurality of database units to point to a memory location of the network packet data in one of the packet capture repository and the file system; and
generating an index bit mask on each database unit of the plurality of database units, the index bit mask providing an identification of a particular packet header, packet flow or packet content attribute in the database unit.

2. The method of claim 1, wherein a size of each database unit of the plurality of database units is based on a size of the header, packet flow, and/or content information designated for storage in the respective database unit.

3. The method of claim 1, further comprising computing a hash value for certain input data from the plurality of database units using a mathematical hash function for a more efficient representation of the certain input data.

4. The method of claim 1, further comprising checking for a presence of a network packet data of interest by identifying a set bit in one or more of the plurality of bit masks.

5. The method of claim 1, further comprising querying the plurality of database units to extract a matched packet data in one of the packet capture repository and the file system.

6. The method of claim 5, further comprising reconstructing a packet flow based on the matched packet data.

7. The method of claim 6, wherein reconstructing the matched packet data includes presenting information associated with the matched packet data in a suitable format to convenience analysis of the presented information.

8. The method of claim 5, further comprising performing at least one of data analytics, data statistics, data forensics, and data metrics based on the matched packet data in one of the packet capture repository and the file system.

9. The method of claim 5, further comprising querying a database to apply a pattern matching scheme to extract the matched packet data in one of the packet capture repository and the file system.

10. The method of claim 1, wherein the header, flow or content information associated with the network packet data comprises one or more of a protocol type, an application type, an encapsulation type, a physical identifying information, a source identification data, or a destination identification data.

11. The method of claim 10, wherein the protocol type associated with the network packet data comprises at least one of a hypertext transfer protocol (HTTP), a simple mail transfer protocol (SMTP), a remote procedure call (RPC) protocol, voice over internet protocol (VoIP), a peer-to-peer protocol, a file transfer protocol (FTP), a streaming media protocol, and an instant messaging protocol.

12. The method of claim 1, wherein an artifact type associated with the network packet data comprises at least one of a word processing document, a spreadsheet document, a database, a multimedia content, a multimedia file, an e-mail, an instant messaging communication, a compressed file, an executable file, a web page, a presentation document, a program file, and a data package.

13. The method of claim 1, further comprising storing at least one of the index bit mask, the plurality of database units, or a hash value computed for certain input data from the plurality of database units in at least one of a compressed format or an encrypted format for efficient and secure recording.

14. A method of network database maintenance comprising:
providing a memory slot allocation of a fixed size, the slot configured to store in real time a flow of packets over a network;
providing a plurality of database units for the slot, each of the plurality of database units being designated to store a particular packet header, packet flow or content attribute of the packets stored in the slot;
inserting in real-time a packet header, packet flow or content information in the plurality of database units, the packet header, packet flow or content information associated with the network packet data stored in the slot,
indexing each of the plurality of database units to point to a memory location of the network packet data in the slot;
computing a hash on certain input values from the plurality of database units for the purpose of more efficient representation of the certain input data; and
providing an index bit mask for each of the plurality of database units, the index bit masks configured to include a bit for each of the particular packet header, packet flow, hash value, or content attribute identified for a particular database unit.

15. The method of claim 14, wherein a size of each database unit of the plurality of database units is based on a size of the header, packet flow, or content information associated with the network packet data included thereof.

16. The method of claim 14, further comprising:
allocating a first database unit for a first packet header attribute, the first packet header attribute having a plurality of possible states; and
setting a first bit in a first bit mask for the first packet header attribute, the bit associated with one particular state of the plurality of possible states.

17. The method of claim 16, further comprising:
querying the first bit mask to determine whether the first bit is set;
querying the first database unit if the bit is set to identify a location of packet data in one of the packet capture repository and the file system, the packet data having a header attribute state corresponding to the first bit.

18. The method of claim 17, further comprising reconstructing the matched packet data in one of the packet capture repository and the file system.

19. The method of claim 18, comprising querying the database to apply a pattern matching scheme to extract the matched packet data in one of the packet capture repository and the file system.

20. The method of claim 17, further comprising performing at least one of data analytics, data statistics, data forensics, and data metrics based on the matched packet data in one of the packet capture repository and the file system.

21. The method of claim 14, wherein the header, packet flow or content information associated with the network packet data comprises one or more of a protocol type, an application type, an encapsulation type, a physical identifying information, a source identification data, or a destination identification data.

22. The method of claim 21, wherein the protocol type associated with the network packet data comprises at least one of a hypertext transfer protocol (HTTP), a simple mail transfer protocol (SMTP), a remote procedure call (RPC) protocol, voice over internet protocol (VoIP), a peer-to-peer protocol, a file transfer protocol (FTP), a streaming media protocol, and an instant messaging protocol.

23. The method of claim 22, wherein reconstructing the matched packet data includes presenting information associated with the matched packet data in a suitable format to convenience analysis of the presented information.

24. The method of claim 14, wherein an artifact type associated with the network packet data comprises at least one of a word processing document, a spreadsheet document, a database, a multimedia content, a multimedia file, an e-mail, an instant messaging communication, a compressed file, an executable file, a web page, a presentation document, a program file, and a data package.

25. The method of claim 14, further comprising storing at least one of the index bit mask, the plurality of database units, or the hash in at least one of a compressed format or an encrypted format on a file system.

26. A computing system comprising:
one of a packet capture repository and a file system to store a network packet data, the network packet data including a header and content information; and
an index module to index each database unit of a plurality of database units to point to a memory location of the network packet data in one of the packet capture repository and the file system, a plurality of index bit masks being created on at least one of each database unit of the plurality of database units or each hashed representation of each database unit of the plurality of database units to facilitate grouping of a similar header or content information associated with the network packet data sequentially recorded in real-time in the plurality of database units in an order of arrival of the network packet data.

27. The system of claim 26, wherein the network packet data is from one of an Asynchronous Transfer Mode (ATM) network, an Ethernet, a 3G network, a 4G network, and a wireless network.
